(19) United States
(12) Patent Application Publication
(10) Pub. No.: US 2018/0148362 A1
(43) Pub. Date: May 31, 2018

(54) VEHICLE-MOUNTED PORTABLE APPARATUS FOR CLARIFICATION AND DISINFECTION OF WASTEWATER PRODUCED BY THE WASHING OF ROAD DRAINAGE INLETS AND DRAINS AND TUNNELS, AND METHOD FOR CLARIFICATION AND DISINFECTION OF WASTEWATER PRODUCED BY THE WASHING OF ROAD DRAINAGE INLETS AND DRAINS AND TUNNELS

(71) Applicant: CAPPELLOTTO S.P.A., Gaiarine (IT)

(72) Inventor: Luigi CAPPELLOTTO, Gaiarine (IT)

(21) Appl. No.: 15/736,655

(22) PCT Filed: Jun. 10, 2016
(86) PCT No.: PCT/EP2016/063290

§ 371 Date: Dec. 14, 2017

(30) Foreign Application Priority Data
Jun. 16, 2015 (IT) 102015000024245

(51) Int. Cl. C02F 9/00; B01D 21/01; B01D 21/24; B01D 21/26; B01D 21/30; B01D 21/00; B01D 36/04; E03F 7/10; B01D 36/02; C02F 1/38; C02F 1/00; C02F 1/50; C02F 1/56; C02F 1/66; C02F 101/20; C02F 103/00

(52) U.S. Cl. CPC C02F 9/00; C02F 2303/04; B01D 21/2444; B01D 21/267; B01D 21/302; B01D 21/0012; B01D 36/04; B01D 36/045; E03F 7/103; B01D 36/02; C02F 1/385; C02F 1/004; C02F 1/50; C02F 1/56; C02F 1/66; C02F 2001/007; C02F 2101/20; C02F 2103/001; C02F 2201/008; C02F 2209/06; C02F 2209/11; B01D 21/01

(57) ABSTRACT

A vehicle-mounted portable apparatus for clarification and disinfection of wastewater produced by the washing of road drainage inlets and drains and tunnels, includes: a sludge collecting tank; a filter for coarse filtering of the sludge in the tank and a filter for finer filtration; and a dosage unit for pH adjustment additives. The apparatus includes a mixer for adding additives for purifying and disinfecting the sludge; a cyclone device for separating water from the sludge; and collection and settling elements for the separated water. The apparatus further includes a hydraulic line for the separated water for connection between the separation cyclone and collection and a settling component for the separated water, a dosage unit for disinfection additives provided on the hydraulic line for the separated water; and a hydraulic line for connection between the collection and settling component.

### TECHNICAL FIELD

The present disclosure relates to a vehicle-mounted portable apparatus for clarification and disinfection of wastewater produced by the washing of road drainage inlets and drains and tunnels.

### BACKGROUND

Apparatuses for clarification and disinfection of wastewater produced by the washing of road drainage inlets and drains and tunnels which can be transported on vehicles are currently known.

These apparatuses comprise a recycling system that allows reuse of a fraction of the aspirated water, by way of the separation of a substantial fraction of the suspended solid particles, which otherwise might damage the high-pressure pump or the pipes that are part of such apparatus.

This water recycling system therefore ensures a constant availability of clean water without resorting to external supplies.

Moreover, such a system allows to thicken the sewer wastewater and consequently transport larger quantities of solid material containing minimal fractions of water.

Although these apparatuses are widespread and appreciated, they are limited to coarse separation by flocculation and subsequent settling of the suspended sludge on the wastewater produced by the washing of road drainage inlets or tunnels, without performing particular treatments to restore the best possible characteristics for the water.

Furthermore, in these apparatuses the sludge separated by flocculation is confined in appropriately provided compartments that are difficult to clean.

### SUMMARY

The aim of the present disclosure is to provide a vehicle-mounted portable apparatus for clarification and disinfection of wastewater produced by the washing of road drainage inlets and tunnels that is capable of obviating the cited limitations of mobile apparatuses of the known type.

Within this aim, the disclosure provides an apparatus that is capable of a better treatment for purifying recycled water.

The disclosure also provides an apparatus that is simpler to clean than known mobile apparatuses.

The disclosure further provides an apparatus in which the discharge of aspirated and settled sludge is more practical.

These aims and advantages that will become better apparent hereinafter, are achieved by providing a vehicle-mounted portable apparatus for clarification and disinfection of wastewater produced by the washing of is road drainage inlets and drains and tunnels, characterized in that it comprises a sludge collecting tank, which is divided by means of two partitions into three compartments, a first compartment for aspirated sludge, a second compartment for first filtration sludge, and a third compartment for separated sludge,

a first filter for coarse filtering of the sludge in the tank,

a second filter for finer filtration with respect to said first filter,

a dosage unit for pH adjustment additives,

mixing means for the addition of additives for purifying and disinfecting the sludge,

a hydraulic line for connection between said second filter and said mixing means, with sludge transfer pump,

a cyclone device for separating the water from the sludge,

collection and settling means for the water separated from the sludge,

a hydraulic line for the separated water, for connection between said separation cyclone and said collection and settling means for said separated water, a dosage unit for disinfection additives being provided on said hydraulic line for the separated water,

a hydraulic line for connection between said collection and settling means with a high-pressure pump for propelling the treated water toward uses,

a hydraulic line for discharging treated water with a turbidity control sensor.

### BRIEF DESCRIPTION OF THE DRAWINGS

Further characteristics and advantages of the disclosure will become better apparent from the description of a preferred but not exclusive embodiment of the apparatus according to the disclosure, illustrated by way of non-limiting example in the accompanying drawings, wherein:

FIG. 1 is a schematic view of the apparatus according to the disclosure.

### DETAILED DESCRIPTION OF THE DRAWINGS

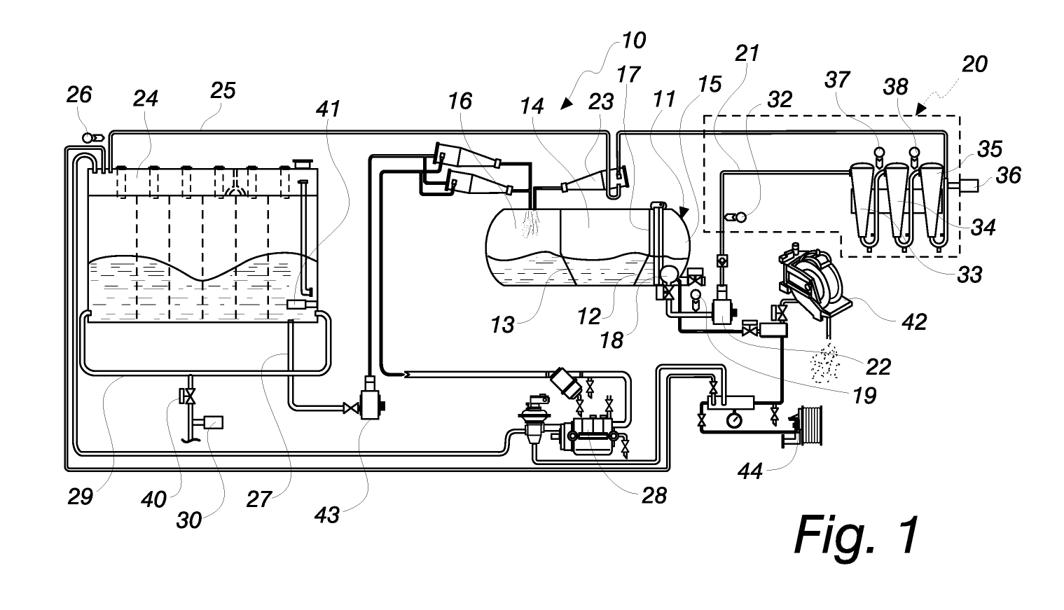

With reference to FIG. 1, a vehicle-mounted portable apparatus for clarification and disinfection of wastewater produced by the washing of road drainage inlets and drains and tunnels, according to the disclosure, is designated generally by the reference numeral 10.

Such apparatus 10 comprises:

a sludge collecting tank 11, which is divided by means of two partitions, a first one 12 and a second one 13, into three compartments, respectively 14, 15 and 16, a first compartment 14 for aspirated sludge, a second compartment 15 for first filtration sludge, and a third compartment 16 for separated sludge,

a first filter 17 for coarse filtering of the sludge in the tank,

a second filter 18 for finer filtration with respect to said first filter 17,

a dosage unit 19 for pH adjustment additives,

mixing means 20 for the addition of additives for purifying and disinfecting the sludge,

a hydraulic line 21 for connection between said second filter 18 and the mixing means 20, with sludge transfer pump 22,

a cyclone device 23 for separating the water from the sludge,

collection and settling means 24 for the water separated from the sludge,

a hydraulic line 25 for the separated water, for connection between the separation cyclone 23 and the collection and settling means 24 for the separated water, a dosage unit 26 for disinfection additives being provided on the hydraulic line for the separated water,

a hydraulic line 27 for connection between said collection and settling means 24 with a high-pressure pump 28 for propelling the water toward generic uses,

a hydraulic line 29 for discharging treated water with a turbidity control sensor 30.

A cock 40 is connected to the turbidity control sensor 30 and is controlled by means of a clearance given by such sensor 30, which blocks the discharge if the water does not have the minimum characteristics for discharging it into a natural receiving body of water, for example a river, instead of into a pipe directed to a purifier.

The disinfection additive dosage unit 26 reduces the bacteriological burdens and the viruses that are present in the water, making it safe for an operator who might come into contact with it or might inadvertently ingest it, with great advantage for the health of such operator.

The first filter 17, for coarse filtration of the sludge in the tank, in the present constructive example is constituted by the upper part of the second partition 12, which is provided with filtration holes.

The second partition 13 is of the movable or openable type.

The second filter 18, for finer filtration with respect to such first filter 17, is constituted by a rotating filter.

In the embodiment described herein of the apparatus 10 according to the disclosure, which is a non-limiting example of said disclosure, the mixing means 20, for the addition of additives for sludge purification and disinfection, comprise:

a first dosage unit 32 of additives for separating heavy metals, which is arranged on said hydraulic line 21 for connection between such second filter 18 and the mixing means 20,

three mixing cyclones 33, 34, 35 connected in series,

a pH control probe 36 arranged at the output of the last mixing cyclone 35,

a dosage unit 37 for an anionic polyelectrolyte, arranged between a first mixing cyclone 33 and a second mixing cyclone 34,

a dosage unit 38 for a cationic polyelectrolyte, arranged between the second mixing cyclone 34 and the third mixing cyclone 35.

The collection and settling means 24 for the water separated from the is sludge are constituted by a tank or by a tub or by the water tanks of a transport vehicle.

Inside the collection and settling means 24 there is a redox sensor 41 for controlling the level of oxidation of the water, the measurements of which are used to calibrate appropriately the dosage units of the mixing means 20.

The high-pressure pump 28 is, for example, of the type with plunger pistons, which is adapted to serve a washing unit 42 and 44 of a per se known type, and is preceded by a booster pump 43 that is designed to determine the correct operating pressure at the input of the high-pressure pump 28.

The disclosure also relates to a vehicle for aspirating liquid waste and for cleaning with high-pressure water, characterized in that it comprises onboard a portable apparatus 10 as described above.

The disclosure also relates to a method for clarification and disinfection of wastewater produced by the washing of road drainage inlets and tunnels, provided for example with an apparatus 10 as described above, characterized in that it comprises the following operations:

performing a first coarse filtration of the aspirated sludge,

performing a second filtration that is finer than the previous first filtration,

adding additives for pH adjustment,

adding additives for heavy metal separation,

performing a first mixing of the second filtration sludge with such additives,

checking the pH after the first mixing,

adding an anionic polyelectrolyte,

performing a second mixing of the sludge that exits from the first mixing with such anionic polyelectrolyte,

adding a cationic polyelectrolyte,

performing a third mixing of the sludge that exits from the second mixing with such cationic polyelectrolyte,

separating the sludge that exits from such third mixing from the water,

sending the separated water to means for collecting the treated water.

In practice it has been found that the disclosure achieves the intended aims and advantages.

In particular, the disclosure provides an apparatus that is not limited to coarse separation by flocculation and subsequent settling of the sludge suspended on the wastewater derived from the washing of road tunnels or drainage inlets but is capable of performing the following treatments to restore the best possible characteristics:

pH reading and neutralization;

sludge and detergent separation

heavy metal separation

water disinfection.

Moreover, the disclosure provides an apparatus which, during discharge into a natural receiving body of water, constantly monitors the treated water, and which, if such water does not comply with the parameters required by applicable statutory provisions, blocks the discharge, causing the water to be reprocessed.

Furthermore, differently from other systems of the known type, the disclosure provides an apparatus in which the sludge separated by flocculation remains inside the sludge tank and not in other compartments that are difficult to clean; the sludge in the tank is divided by a movable partition that allows to keep the aspirated sludge and the settled sludge separate and to discharge them simultaneously or separately.

The disclosure thus conceived is susceptible of numerous modifications and variations, all of which are within the scope of the appended claims; all the details may further be replaced with other technically equivalent elements.

In practice, the components and materials used, so long as they are is compatible with the specific use, as well as the contingent shapes and dimensions, may be any according to requirements and to the state of the art.

The disclosures in Italian Patent Application No. 102015000024245 (UB2015A001424) from which this application claims priority are incorporated herein by reference.

1-7. (canceled)

8. A vehicle-mounted portable apparatus for clarification and disinfection of wastewater produced by the washing of road drainage inlets and drains and tunnels, comprising:
a sludge collecting tank, which is divided by means of two partitions into three compartments, a first compartment for aspirated sludge, a second compartment for first filtration sludge, and a third compartment for separated sludge,
a first filter for coarse filtering of the sludge in the tank,
a second filter for finer filtration with respect to said first filter,
a dosage unit for pH adjustment additives,
mixing means for the addition of additives for purifying and disinfecting the sludge,
a hydraulic line for connection between said second filter and said mixing means, with sludge transfer pump,
a cyclone device for separating the water from the sludge,
collection and settling means for the water separated from the sludge,
a hydraulic line for the separated water, for connection between said separation cyclone and said collection and settling means for said separated water, a dosage unit for disinfection additives being provided on said hydraulic line for the separated water,
a hydraulic line for connection between said collection and settling means with a high-pressure pump for propelling the treated water toward uses, and
a hydraulic line for discharging treated water with a turbidity control sensor.

9. The apparatus according to claim 8, wherein said first filter, for coarse filtering of the sludge in the tank, is constituted by the upper part of the second partition, provided with filtration holes.

10. The apparatus according to claim 8, wherein said second filter, for finer filtration with respect to said first filter, is constituted by a rotating filter.

11. The apparatus according to claim 8, wherein said mixing means, for the addition of additives for purifying and disinfecting the sludge, comprise:
a first dosage unit of additives for separating heavy metals, which is arranged on said hydraulic line for connection between said second filter and said mixing means,
three mixing cyclones connected in series,
a pH control probe arranged at the output of the last mixing cyclone,
a dosage unit for an anionic polyelectrolyte, arranged between a first mixing cyclone and a second mixing cyclone, and
a dosage unit for a cationic polyelectrolyte, arranged between said second mixing cyclone and a third mixing cyclone.

12. The apparatus according to claim 8, wherein said collection and settling means for the water separated from the sludge are constituted by a tank or a tub or by the water tanks of a transport vehicle.

13. A vehicle for aspirating liquid waste and cleaning with high-pressure water, comprising onboard a portable apparatus according to claim 8.

14. A method for clarification and disinfection of wastewater derived from the washing of road drainage inlets and tunnels, comprising the following steps:
performing a first coarse filtration of aspirated sludge,
performing a second filtration, which is finer than the previous first filtration,
adding additives for pH adjustment,
adding additives for heavy metal separation,
performing a first mixing of the second filtration sludge with said additives,
controlling the pH after first mixing,
adding an anionic polyelectrolyte,
performing a second mixing of the sludge that exits from the first mixing with said anionic polyelectrolyte,
adding a cationic polyelectrolyte,
performing a third mixing of the sludge that exits from the second mixing with said cationic polyelectrolyte,
separating from the water the sludge that exits from said third mixing, and
sending the separated water to means for collecting the treated water.
